(19) United States
(12) Patent Application Publication
(10) Pub. No.: US 2019/0108453 A1
(43) Pub. Date: Apr. 11, 2019

(54) PREDICTING ACTIONS BASED ON PSYCHOGRAPHIC OPTIMIZATION OF BIOMETRIC DATA

(71) Applicant: Formotiv LLC, West Chester, PA (US)

(72) Inventor: Andrew Christopher Schwabe, Ho Chi Minh (VN)

(21) Appl. No.: 16/152,782

(22) Filed: Oct. 5, 2018

Related U.S. Application Data
(60) Provisional application No. 62/568,805, filed on Oct. 6, 2017.

(51) Int. Cl. G06N 5/04; G06N 99/00

(52) U.S. Cl. CPC G06N 5/047; G06N 99/005

(57) ABSTRACT

Systems, methods, and computer readable mediums are provided for predicting a sequence of actions based on psychographic measures determined from biometric information. Data received from a computing device can include biometric information characterizing a pattern of user interaction during completion of an objective requiring a first set of actions be performed in a first sequence. A psychographic measure characterizing a user's state while performing the objective can be determined. Using the determined psychographic measure and a predictive model, a second sequence associated with the objective can be determined and can include a second set of actions different than the first set of actions. The predictive model can be trained to output the second sequence to affect the psychographic measure of the user completing the objective according to the second set of actions. The second sequence can be transmitted to the computing device for execution.

### CROSS-REFERENCE TO RELATED APPLICATION

The present application claims the benefit of and priority under 35 U.S.C. § 119(e) to U.S. Provisional Application No. 62/568,805 entitled “A System for Psychographic Optimization of Electronic Input Goals Using Behavioral Biometrics,” filed on Oct. 6, 2017, which is hereby expressly incorporated by reference in its entirety.

### BACKGROUND

Behavioral biometric data can include measurements of human behavior in the context of a user performing a task or objective. In the domain of computer-related technologies, behavioral biometric data can include measurements of a user's behavior or interaction with components of a computing system such as a user's typing speed in a word-processing application, a user's rate of completion providing inputs to multiple input fields in a form or interface that is displayed in a web browser, a user's mouse or cursor movements in a graphical user interface, or similarly related behavior requiring movement of the user's body in order to complete a task or objective in the computing system.

The field of psychographics relates to an area of human psychology including the study of a person's values, personality, activities, behavior, and lifestyles. Psychographic measurements represent qualitative measurements that can be used to describe a user's subjective psychological state, which can include the user's attitude, interests, or opinions towards a particular goal, objective or task to be completed.

Machine learning is an application of artificial intelligence that automates the development of an analytical model by using algorithms that iteratively learn patterns from data without explicit indication of the data patterns. Machine learning is commonly used in pattern recognition, computer vision, email filtering and optical character recognition and enables the construction of algorithms that can accurately learn from data to predict model outputs thereby making data-driven predictions or decisions.

### SUMMARY

Users interacting with interfaces that are configured within computing systems can provide inputs associated with a task or objective to be completed using the computing system. To successfully complete the objective, a user can be required to provide the inputs sequentially by performing individual tasks or actions. A user's motivation and interest to successfully perform the sequence of actions necessary to complete the objective can depend on a variety of factors including the user's physical abilities as well as the user's psychological state. Users can be discouraged from successfully completing an objective based on these same user characteristics. Applications and/or interfaces in computing systems typically do not include feedback mechanisms to determine the user's physical or psychological characteristics in order to present the sequence of actions associated with the objective in a configuration that is optimized for the user's state. In some computing systems, user-defined configuration parameters or settings can be used to adjust the presentation of various interface features, but the configuration parameters do not provide mechanisms for modifying the sequence of actions to be performed so that the sequence of actions is optimized based on the user's state. In addition, analyzing biometric data related to the user's inputs, such as keystroke speed in a document or web-form, mouse or cursor velocity in an interactive user-interface, or manipulation of a controller in a virtual reality or gaming environment, can provide some indication of the user's physical behavior toward completing an objective, but can lack attributes, which can provide insight into a user's non-physical or psychological state in regard to completing the objective. As such, it can be difficult to provide interfaces in computing systems that include a sequence of actions that take into account the user's psychological state and/or successful completion of the objective.

In general, systems, methods, and computer readable mediums are provided herein for predicting a sequence of actions based on psychographic measures determined from biometric information. The biometric information can be included in data received from a computing device that is configured to provide a user with an objective to be performed as a sequence of actions, steps, or user inputs. The computing device can include an input collection mechanism, such as a listening object configured within an application. The input mechanism can be configured to record biometric data associated with a user's input as the user performs the sequence of actions required for successful completion of the objective. The biometric data can be provided to a server for processing to determine psychographic measures of the user's state based on the biometric data associated with the user's performance of one or more actions in the sequence. The server can include a predictive model that has been trained using a machine learning process. Based on receiving the determined psychographic measurements, the predictive model can generate a new or modified sequence of actions for completing the objective that are optimized for successfully completing the objective in view of the determined psychographic measurements. The server can transmit the new or modified sequence of actions to the computing device to be executed and cause the computing device to provide the new or modified sequence of actions to the user for input and completion of the objective. In this way, the systems, methods, and computer readable mediums described herein can alter the computing device to provide a sequence of actions for user input, which are presented in a manner that accounts for the user's state (or psychographic measures) and provides an increased likelihood that the user will successfully complete the objective. Providing the predicted sequence of actions to the computing device in this manner improves the functionality of the computing device with regard to the display, receipt of user input, and the execution of functionality associated with performing an objective requiring user input. As a result, the improved computing device can execute completed objectives more efficiently due to a greater rate of completion than computing devices which do not include the features described herein. In addition, based on receiving and executing the predicted actions, the improved computing device can dynamically regenerate the sequence of actions necessary to perform the objective and thereby reduce the need for increase memory or computing resources required to store and provide multiple statically defined sequences, which can be required for different variants of a particular objective.

In one aspect, a system for predicting a sequence of actions based on psychographic measures determined from biometric information is provided. The system can include a memory storing computer-readable instructions and a plurality of prediction models. The system can also include a processor configured to execute the computer-readable instructions. The instructions, which when executed, can cause the processor to perform operations including receiving data. The received data including biometric information characterizing a pattern of user interaction with a computing device during completion of a first defined objective requiring a first set of actions be performed in a first sequence. The computing device including at least one data processor and configured to provide the first defined objective for user input. The instructions, which when executed, can further cause the processor to determine, using the received data, a psychographic measure characterizing a user state while performing the first defined objective according to the first set of actions performed in the first sequence. The instructions, which when executed, can also cause the processor to determine, using the determined psychographic measure and a predictive model, a second sequence associated with the first defined objective including a second set of actions. The predictive model trained to output the second sequence to affect the psychographic measure of the user completing the first defined objective according to the second set of actions to be provided in the second sequence. The second set of actions different than the first set of actions. The instructions, which when executed, can further cause the processor to transmitting the second sequence to the computing device for execution on the computing device.

In another embodiment, the system can include a second predictive model. The second predictive model trained to output a third sequence to affect the psychographic measure of the user completing a second defined objective according to a third set of actions to be provided in the third sequence. The third set of actions different than the first and second set of actions.

In another embodiment, the first, second, and third sets of actions include a list of actions, the actions included in the list of actions being ranked based on a magnitude of the one or more determined psychographic measurements.

In another embodiment, the system can include instructions, which when executed, can further cause the processor to determine an environmental attribute associated with the received data. The environmental attribute characterizing an attribute of the computing device configured to provide the first defined objective for user input. The instructions, which when executed, can also cause the processor to determine a correlation group based on the received data. The correlation group identifying a group of users for whom the received data includes statistical characteristics satisfying a similarity criteria applied to two or more users of the group of users. The instructions, which when executed, can also cause the processor to determine the second sequence based on the determined correlation group.

In another embodiment, the computing device configured to provide the first defined objective includes a computing device configured to receive user input in a browser-based web form, in a virtual reality environment, in a gaming environment, in a voice-based interaction system, in a text-based interaction system, or in a navigation environment.

In another embodiment, the user state is associated with an attitude, an interest, an opinion, a value, or a belief of a user performing the first defined objective in a first sequence.

In another embodiment, the first set and the second set of actions includes one or more actions requiring user input to cause execution of executable content configured on a computing device.

In another embodiment, the system can include instructions, which when executed, can further cause the processor to perform the operation for providing the second sequence further including providing the second sequence to a computing environment including at least one data processor, the computing environment configured with the computing device and executing an application requiring user input to perform the first defined objective. In another embodiment, the system can include instructions, which when executed, can further cause the processor to perform the operation for providing the second sequence further including integrating the second sequence including the second set of actions into the computing environment. In another embodiment, the system can include instructions, which when executed, can further cause the processor to perform the operation for providing the second sequence further including executing the application to cause the second set of actions to be provided for user input in the application.

In another embodiment, the system can include instructions, which when executed, can further cause the processor to perform the operation for determining the psychographic measurement as an average cumulative increase of an abandonment threshold determined based on successive completion of two or more actions in the first set of actions to be performed in the first sequence. In another embodiment, the abandonment threshold is an average of a deviation of the psychographic measurement associated with an action in the first set of actions, within one standard deviation. The abandonment threshold determined with respect to a sample user group abandoning the first defined objective at the same action in the first set of actions. In another embodiment, the psychographic deviation is determined as a Euclidean distance between the received data associated with a user's performance of one action in the first set of actions and a vector of behavior normal data associated with a user's performance of the same one action in the first set of actions. The behavior normal data included in a training model used in a machine learning process to train the predictive model.

In another embodiment, the received data is generated by an object configured on the computing device and including one or more functions to collect and transmit the received data, via one or more application programming interfaces, to a server including at least one processor.

In another embodiment, the psychographic measure and the second sequence are determined by a server communicatively coupled to the computing device, the server including at least one data processor.

In another aspect, methods for predicting a sequence of actions based on psychographic measures determined from biometric information are also provided. In one embodiment, the method can include receiving data including biometric information characterizing a pattern of user interaction with a computing device during completion of a first defined objective requiring a first set of actions be performed in a first sequence. The computing device including at least one data processor and configured to provide the first defined objective for user input. The method can further include determining, using the received data, a psychographic measure characterizing a user state while performing the first defined objective according to the first set of actions performed in the first sequence. The method can also include determining, using the determined psychographic measure and a predictive model, a second sequence associated with the first defined objective including a second set of actions. The predictive model trained to output the second sequence to affect the psychographic measure of the user completing the first defined objective according to the second set of actions to be provided in the second sequence. The second set of actions different than the first set of actions. The method can further include transmitting the second sequence to the computing device for execution on the computing device.

In another embodiment, the method can include a second predictive model. The second predictive model trained to output a third sequence to affect the psychographic measure of the user completing a second defined objective according to a third set of actions to be provided in the third sequence. The third set of actions different than the first and second set of actions.

In another embodiment, the first, second, and third sets of actions include a list of actions, the actions included in the list of actions being ranked based on a magnitude of the one or more determined psychographic measurements.

In another embodiment, the method can include determining an environmental attribute associated with the received data. The environmental attribute characterizing an attribute of the computing device configured to provide the first defined objective for user input. The method can also include determining a correlation group based on the received data. The correlation group identifying a group of users for whom the received data includes statistical characteristics satisfying a similarity criteria applied to two or more users of the group of users. The method can also further include determining the second sequence based on the determined correlation group.

In another embodiment, the computing device configured to provide the first defined objective includes a computing device configured to receive user input in a browser-based web form, in a virtual reality environment, in a gaming environment, in a voice-based interaction system, in a text-based interaction system, or in a navigation environment.

In another embodiment, the user state is associated with an attitude, an interest, an opinion, a value, or a belief of a user performing the first defined objective in a first sequence.

In another embodiment, the first set and the second set of actions includes one or more actions requiring user input to cause execution of executable content configured on a computing device.

In another embodiment, the method can include providing the second sequence to a computing environment including at least one data processor, the computing environment configured with the computing device and executing an application requiring user input to perform the first defined objective. In another embodiment, the method can also include providing the second sequence further including integrating the second sequence including the second set of actions into the computing environment. In another embodiment, the method can further include providing the second sequence further including executing the application to cause the second set of actions to be provided for user input in the application.

In another embodiment, the method can include determining the psychographic measurement as an average cumulative increase of an abandonment threshold determined based on successive completion of two or more actions in the first set of actions to be performed in the first sequence. In another embodiment, the abandonment threshold is an average of a deviation of the psychographic measurement associated with an action in the first set of actions, within one standard deviation. In another embodiment, the method can include determining the abandonment threshold with respect to a sample user group abandoning the first defined objective at the same action in the first set of actions. In another embodiment, the method can include determining the psychographic deviation as a Euclidean distance between the received data associated with a user's performance of one action in the first set of actions and a vector of behavior normal data associated with a user's performance of the same one action in the first set of actions. The behavior normal data included in a training model used in a machine learning process to train the predictive model.

In another embodiment, the received data is generated by an object configured on the computing device and including one or more functions to collect and transmit the received data, via one or more application programming interfaces, to a server including at least one processor.

In another embodiment, the psychographic measure and the second sequence are determined by a server communicatively coupled to the computing device, the server including at least one data processor.

In another aspect, a computer-readable storage medium containing program instructions for causing a computer to predict a sequence of actions based on psychographic measures determined from biometric information is also provided. The program instructions contained on the computer-readable storage medium perform the method including receiving data including biometric information characterizing a pattern of user interaction with a computing device during completion of a first defined objective requiring a first set of actions be performed in a first sequence. The computing device including at least one data processor and configured to provide the first defined objective for user input. The program instructions further perform the method including determining, using the received data, a psychographic measure characterizing a user state while performing the first defined objective according to the first set of actions performed in the first sequence. The program instructions further perform the method including determining, using the determined psychographic measure and a predictive model, a second sequence associated with the first defined objective including a second set of actions. The predictive model trained to output the second sequence to affect the psychographic measure of the user completing the first defined objective according to the second set of actions to be provided in the second sequence. The second set of actions different than the first set of actions. The program instructions further perform the method including transmitting the second sequence to the computing device for execution on the computing device.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

### DESCRIPTION OF DRAWINGS

These and other features will be more readily understood from the following detailed description taken in conjunction with the accompanying drawings, in which:

FIG. 1 illustrates an example architecture for predict a sequence of actions based on psychographic measures determined from biometric information;

FIGS. 2A-2B illustrate example block diagrams of systems for predict a sequence of actions based on psychographic measures determined from biometric information;

FIG. 3 is a flowchart illustrating one exemplary embodiment of a method for predicting a sequence of actions based on psychographic measures determined from biometric information;

FIGS. 4A-4C illustrate exemplary embodiments of a prediction system operating to determine a sequence of actions based on psychographic measures determined from biometric information;

It is noted that the drawings are not necessarily to scale. The drawings are intended to depict only typical aspects of the subject matter disclosed herein, and therefore should not be considered as limiting the scope of the disclosure.

### DETAILED DESCRIPTION

Determining an appropriate sequence of actions required for completion of an objective can be an important consideration in a wide variety of computing environments. An objective can be a goal or task a user is seeking to perform using the computing environment. Successful completion of the objective frequently requires performing multiple steps or actions in a defined sequence of steps or a workflow. A user interacting with a computing environment to complete an objective can provide inputs related to each action in the sequence, which is presented by the computing environment. In some circumstances, users can not complete an objective due to failing to provide inputs related to one or more actions, which are required in the sequence. For example, consider a user seeking to complete and submit a form, for example, a credit card application provided to the user as an on-line form displayed in a browser in a web-based computing environment. The objective of submitting the form can only be successfully achieved by providing inputs to multiple required fields included in the web form. The sequence of the fields requiring input can be configured by the credit card vendor based on a variety of design and data processing considerations. Depending on how the user responds to the sequence of the fields in the form and his/her psychological state toward successfully completing the objective, the user may or may not provide all the required inputs to successfully submit the form. The user's state can be associated with an attitude, an interest, an opinion, a value, or a belief of performing a defined objective in a particular sequence of actions. For example, if a user is highly motivated to complete and submit the credit card application, the user may not mind that the fields associated with providing complex, detailed financial data such as credit history or existing credit card balances and interest rates, are provided near the beginning of the form and are part of the initial experience of providing inputs to the form. In this example, the user's motivated psychological state to complete and submit the form can influence the user to persist through the complex, data-intensive fields that are configured in the beginning of the form and complete the less complex, personal information fields which can be included later in the form. Understandably, in this example, the user's state would most likely influence the user to complete the form and all required fields even if the form required input of less complex data earlier in the sequence of inputs and the fields associated with the more complex, detailed financial data were required later, near the end of the form.

In some cases, a user can be less inclined to complete and submit the form based on their psychological state, for example, a user who is not interested in a new credit card, who is depressed about their financial status, or perhaps has anxiety about their credit history. In these cases, a credit card application in which the complex, detailed financial data is required early in the sequence of form fields can discourage the user from successfully completing and submitting the form. This user can be more likely to successfully perform the objective, e.g., completing and submitting the form, if the fields for the less-complex, personal information are provided for user input earlier in the form, for example, near the start of the form.

Although the above example pertains to a web-form requiring inputs in a sequential order to facilitate completing and submitting the form, a variety of other computing environments, applications and/or interfaces have similar actions that are require to be performed in a defined order so that an objective can be completed. For example, a virtual reality environment or a gaming application can include objectives that require a user to perform actions in a specific order to successfully complete the objective, such as earning a certain amount of points and/or positioning a character in the game in proximity of an object before acquiring the object for use in a game, or visiting certain scenes or locations in the game before unlocking a next level. Similarly, an email application can require a user to perform a specific sequence of actions necessary to open, save, or print an attachment in an email. A voice or text-based interaction system can require a user to provide certain information in a certain sequence of inputs before a user can be connected to a dedicated customer support resource. A navigation application can require a user to provide a specific sequence of inputs prior to determining a route.

Typically, the aforementioned computing environments, applications, and interfaces are not configured to determine a user's psychological state in regard to an objective to be completed. In addition, generating a sequence of actions that are required to complete an objective based on the user's psychological state is typically not a feature found in existing computing environments, applications, or interfaces. As a result, applications or interfaces configured without such features can generate a higher rate of failed or partially completed objectives due to ignoring a user's psychological state when providing inputs in a specific sequence that are required to complete an objective. Higher objective failure rates can reduce the efficiency of limited computing and personnel resources required to store data or troubleshoot the failed or partially completed objectives, respectively. A higher rate of successfully completed objectives, and thereby a greater rate of user adoption of the computing environment or application used to perform the objective, can be achieved by employing mechanisms to collect data as a user interacts with the application or interface and processing the data to determine a sequence of actions for completing the objective that are optimized for the psychological state of the user. For example, biometric data related to a user's pattern of physical interaction with an interface or application can be used to infer psychographic characteristics of the user. Biometric data has been used to determine behavioral patterns in a single user's historic records, looking for anomalies compared to the user's past behavioral patterns. In this way, biometric data can be used to identify authentication behaviors that can be used to test risk and fraud cases. Based on the psychographic characteristics determined based on the biometric data, a sequence of actions can be predicted, which are optimized based on the psychographic state of the user. In this way, a broad range of users with varying psychographic characteristics are more likely to achieve higher rates of objective completion in a myriad of computing environments, applications, and interfaces to the benefit of the user as well as the business or entity associated with the objective being performed by the user.

An improved prediction system is provided herein including a system, methods, and computer-readable medium for predicting a sequence of actions based on psychographic measures determined from biometric information. Client computing devices receiving user inputs or data to perform an objective can be configured with functionality interfaces to a server to process the data. The functionality on the client computing device can collect and transmit data regarding the user's inputs, including biometric data, to the server for processing to determine a psychographic measurement characterizing the user's state when performing actions required to complete an objective. Upon determining the psychographic measures, the server can be configured with a predictive model that has been trained in a machine learning process to determine and generate a sequence of actions that are optimized for the psychographic state of the user in regard to completing the specific objective. The optimized sequence of actions can then be transmitted back to the computing device and can be further integrated or executed on the computing device to alter or modify the sequence of actions associated with the objective. The improved prediction system can therefore predict and generate a sequence of actions for completing an objective based on the psychographic measures that were determined based on the user's biometric data. In this way, the improved prediction system can modify the functionality of computing devices to provide enhanced interfaces, which include the optimized sequence of actions resulting in higher rates of objective completion. An additional benefit provided by the improved prediction system can include an improved user experience for users interacting with a computing environment, application, and/or interface to perform a specific objective.

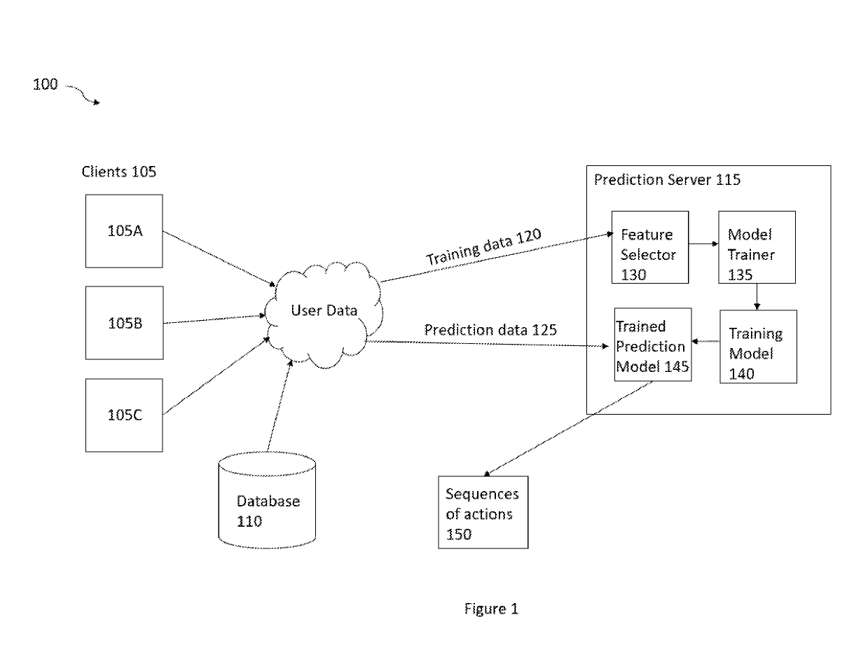

FIG. 1 is a diagram illustrating an example architecture 100 for predicting a sequence of actions based on psychographic measures determined from biometric information. The architecture 100 includes clients 105, database 110, and server 115, which can be communicatively coupled over a network.

As shown in FIG. 1, the architecture 100 includes clients 105, e.g., clients 105A-105C. The clients 105 can include a large-format computing devices or any other fully functional computing device, such as a desktop computers or laptop computers, can transmit user data to prediction server 115. Additionally, or alternatively, other computing devices, such as a small-format computing devices 105 can also transmit user data to the prediction server 115. Small-format computing devices 105 can include a tablet, smartphone, personal digital assistant (PDA), or any other computing device that can have more limited functionality compared to large-format computing devices. For example, client 105A can include a laptop configured with a web-browser to display a web form required to be completed in order to submit a credit card application. Client 105B can include a gaming console interfaced with a controller which receives input from a user to navigate through various scenes in the game to reach a desired objective. Client 105C can include a navigation system configured to receive user inputs and generate step by step directions guiding the user to a specific location. User data can also be stored in a database, for example database 110, to be transmitted to prediction server 115. The clients 105 can include memory storing data and applications related to an objective to be performed by a user completing a sequence of actions.

As further shown in FIG. 1, user data can be transmitted from the clients 105 and/or from the database 110 to the prediction server 115. In some embodiments, the user data includes training input 120 that is transmitted to the prediction server 115 for use in a machine learning process. The training input 120 is used to train a machine learning algorithm in a machine learning process in order to generate a training model capable of predicting sequences of actions based on a wide variety of received user data. In some embodiments, the user data includes prediction data 125 that is transmitted to a prediction server 115 as inputs to the generated model that was trained in the machine learning process using the training input. The user data can include biometric data that can be utilized to determine a psychographic measure of the user's state while performing an objective according to a set of actions in a sequence. For example, the user data can include biometric information or data identifying a behavior or pattern of behavior associated with the user providing the data. The biometric data can include data such as typing speed, input device velocity and directional movement, time spent with visual goals or inputs in focus, keystroke versus backspace ratios, discrete changes or corrections to form inputs or repeated input goals, and similarly related activities that require manual bodily movement in order to register an electronic input.

As shown in FIG. 1, the architecture 100 includes a prediction server 115 to receive the user data and generate sequences of actions based on the psychographic measures that are determined from the user data and specifically from the biometric data included in the user data. In broad overview, the prediction server 115 functions in the training aspect of a machine learning process to receive user data as training input and generate a training model for use in predicting sequences of actions based on psychographic measurements. The prediction server 115 includes a feature selector 130, which is used in the training aspect of the machine learning process to select subsets of features in the user data. The prediction server 115 also includes a model trainer 135 which uses a selected machine learning algorithm to process the selected subsets of features as inputs and generate a new training model 140 which can be subsequently used outside of the machine learning process to predict sequences of actions based on the received the prediction data 125.

As shown in FIG. 1, the prediction server 115 includes a feature selector 130. During the training aspect of the machine learning process, the feature selector 130 receives user data and selects subsets of features in the user data which are used as training input to train the selected machine learning algorithm. For each selected subset of features in the training input, the selected machine learning algorithm can be trained to predict sequences of actions associated with the subset of features for which the selected machine learning algorithm was trained. The trained machine learning algorithm can then be output as a new trained model (e.g., training model 140), which can then be subsequently applied to an individual's user data (e.g., prediction data input 125) to determine sequences of actions based on the psychographic measurements determined from the user data.

The prediction server 115 also includes a model trainer 135. In some embodiments, the model trainer 135 can be included in the prediction server 115. In other embodiments, the model trainer 135 can be located remotely from the prediction server 115. During the training aspect of the machine learning process, the model trainer 135 receives the training input including the selected subsets of features from the feature selector 130 and iteratively applies the subsets of features to the previously selected machine learning algorithm to assess the performance of the algorithm. As the machine learning algorithm processes the training input, the model trainer 135 learns patterns in the training input that map the machine learning algorithm variables to the target output data (e.g., the predicted sequences of actions) and generates a training model that captures these relationships. For example, as shown in FIG. 1, the model trainer 135 outputs the training model 140. As further shown in FIG. 1, the training model 140 that is output can be a trained prediction model 145.

As further shown in FIG. 1, the prediction server 115 includes a trained prediction model 145. The trained prediction model 145 is a model or algorithm that has been generated as a result of the model training performed during the training aspect of the machine learning process. Once trained, the trained prediction model 145 can operate outside of a machine learning process to receive user data as prediction data 125 and generate sequences of actions 150 for a given user in regard to a specific objective. For example, the trained prediction model 145 outputs sequences of actions 150 that are optimized for client 105A based on the psychographic measurements determined from the user data collected from client 105A in regard to completing the credit card application provided in the web-form.

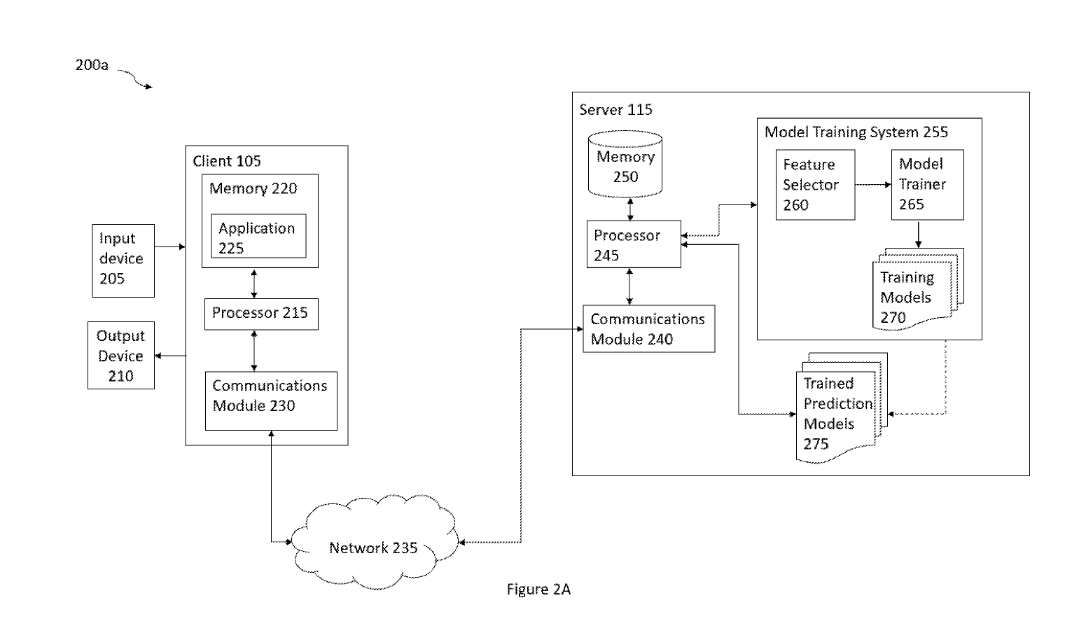

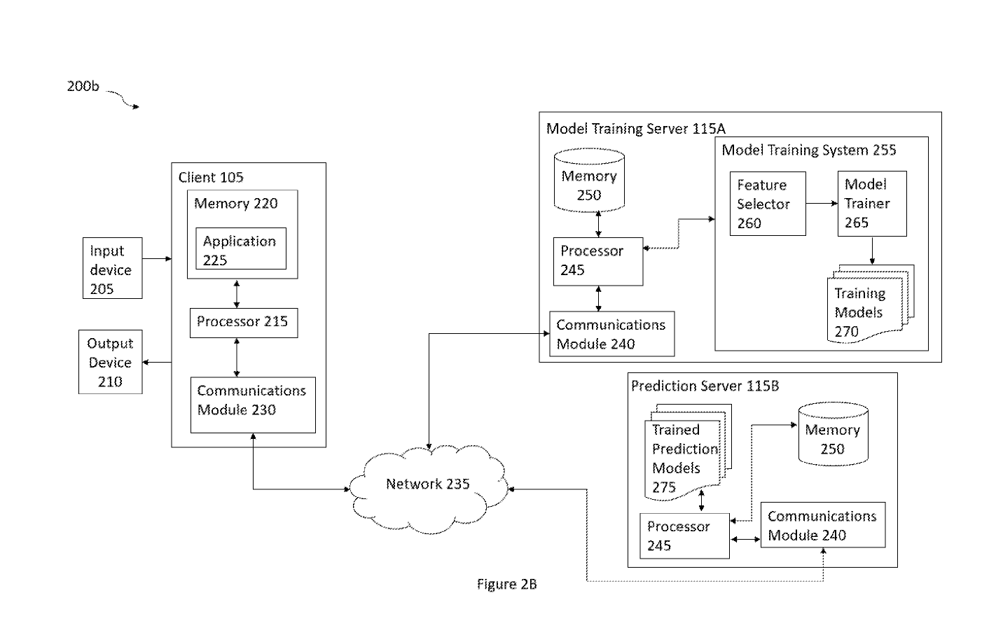

FIG. 2A is an example block diagram of a system 200a for predicting a sequence of actions based on psychographic measures determined from biometric information using machine learning according to some embodiments. System 200a includes an input device 205 and an output device 210 coupled to a client 105, such as the client 105 described in relation to FIG. 1. The client 105 includes a processor 215 and a memory 220 storing an application 225. The client 105 also includes a communications module 230 connected to network 235. System 200a also includes a server 115, such as server 115 described in relation to FIG. 1. The server 115 includes a communications module 240, a processor 245 and a memory 250. The server 115 also includes a model training system 255. The model training system 255 includes a feature selector 260, a model trainer 265 and one or more training models 270. The model training system 255 includes similar components and performs similar operations as the prediction server 115 shown in FIG. 1, except where indicated otherwise in the foregoing description. The server 115 also includes one or more trained prediction models 275, which as described in relation to FIG. 1 are shown in dotted lines to indicate that the training models 270, that were output during the training performed in the machine learning process, can be one or more trained prediction models, such as the one or more trained prediction models 275.

As shown in FIG. 2A, the system 200a includes an input device 205. The input device 205 receives user input and provides the user input to client 105. The input device 205 can include a keyboard, mouse, microphone, stylus, game controller, joy stick, hand/or any other device or mechanism used to input user data or commands to an application or user interface on a client, such as client 105. In some embodiments, the input device 205 can include haptic, tactile or voice recognition interfaces to receive the user input, such as on a small-format device. In some embodiments, the input device 205 can be an input device associated with a virtual reality environment or an augmented reality environment.

The system 200a also includes a client 105. The client 105 communicates via the network 235 with the server 115. The client 105 receives input from the input device 205. The client 105 can be, for example, a large-format computing device, such as large-format computing device 105 as described in relation to FIG. 1, a small-format computing device (e.g., a smartphone or tablet), such as small-format computing device 105, or any other similar device having appropriate processor, memory, and communications capabilities to transmit a received user input. The client 105 can be configured to receive, transmit, and store user data associated with predicting sequences of action based on psychographic measures determined from biometric information included in the data received from client 105.

As further shown in FIG. 2A, the client 105 includes a processor 215 and a memory 220. The processor 215 operates to execute computer-readable instructions and/or data stored in memory 220 and transmit the computer-readable instructions and/or data via the communications module 230. The memory 2220 can store computer-readable instructions and/or data associated with predicting a sequence of actions based on a determined psychographic measure. For example, the memory 220 can include a database of user data, such as a database 110 as shown in FIG. 1. The memory 220 includes an application 225. The application 225 can be, for example, an application to receive user input for use in performing a sequence of actions associated with an objective to be completed using the application 225. The application 225 can be considered to generate user data, including biometric data, corresponding to the user input provided in relation to performing or attempting to perform some or all of the actions included in a sequence. In some embodiments, the application 225 can receive user input for use in determining a predicted sequence of actions based on psychographic measurements. The application 225 can include textual, graphical, or touch-based user interfaces to receive user input for a sequence of actions to be completed for an objective.

As shown in FIG. 2A, the client 105 includes a communications module 230. The communications module 230 transmits the computer-readable instructions and/or user data stored on or received by the client 105 via network 235. The network 235 connects the client 105 to the server 115. The network 235 can include, for example, any one or more of a personal area network (PAN), a local area network (LAN), a campus area network (CAN), a metropolitan area network (MAN), a wide area network (WAN), a broadband network (BBN), the Internet, and the like. Further, the network 235 can include, but is not limited to, any one or more of the following network topologies, including a bus network, a star network, a ring network, a mesh network, a star-bus network, tree or hierarchical network, and the like.

As further shown in FIG. 2A, the server 115 operates to receive, store and process the computer-readable instructions and/or user data generated and received by client 105. In some embodiments, the server 115 can receive user data directly from one or more clients 105. The server 115 can be any device having an appropriate processor, memory, and communications capability for hosting a machine learning process. In certain aspects, one or more of the servers 115 can be located on-premises with client 105, or the server 115 can be located remotely from client 105, for example in a cloud computing facility or remote data center. The server 115 includes a communications module 240 to receive the computer-readable instructions and/or user data transmitted via network 235. The server 115 also includes one or more processors 245 configured to execute instructions that when executed cause the processors to determine predicted sequences of actions based on determining psychographic measurements from biometric information. The server 115 also includes a memory 250 configured to store the computer-readable instructions and/or user data associated with predicting sequences of actions based on determining psychographic measurements from biometric information. For example, memory 250 can store one or more training models, such as the training models 270 used during the training of a machine learning process to generate a trained prediction model 275 to output predicted sequences of actions based on determining psychographic measurements from biometric information. In some embodiments, memory 250 can store one or more training models, such as trained prediction models 275 that were similarly generated during a machine learning process and were trained to output predicted sequences of actions for different objectives, users, psychographic characteristics, and/or correlation groups (e.g., groups of users for whom their received biometric information is statistically correlated). In some embodiments, the memory 250 can store one or more machine learning algorithms that will be used to generate one or more training models. In some embodiments, the memory 250 can store user data that is received from client 105 and is used as a training dataset in the machine learning process in order to train a prediction model. In some embodiments, the memory 250 can store one or more trained prediction models 275 that are used to predict sequences of actions based on determining psychographic measurements from biometric information.

As shown in FIG. 2A, the server 115 includes a model training system 255. The model training system 255 functions in a machine learning process to receive user data as training input and processes the user data to train one or more training models. The model training system 255 includes a feature selector 260, a model trainer 265, and one or more training models 270. In some embodiments, the training models 270 that are generated and output as a result of the machine learning process are configured on server 115 as standalone components on server 115. For example, the trained prediction models 275 are configured on server 115 to process user data and output a predicted sequence of actions based on determining psychographic measurements from biometric information. In some embodiments, the trained prediction models 275 are stored in memory 250 on server 115.

The model training system 255 is configured to implement a machine learning process that receives user data as training input and generates a training model that can be subsequently used to predict sequences of actions based on determining psychographic measurements from biometric information. The components of the machine learning process operate to receive user data as training input, select unique subsets of features within the user data, use a machine learning algorithm to train a model based on the subset of features in the training input and generate a training model that can be output and used for future predictions based on a variety of received user data.

As shown in FIG. 2A, the model training system 255 includes a feature selector 260. The feature selector 260 operates in the machine learning process to receive user data and select a subset of features from the user data which will be provided as training inputs to a machine learning algorithm. In some embodiments, the feature selector 260 can select a subset of features corresponding to different categories of biometric data included in the received user data or different correlation groups such that the machine learning algorithm will be trained to predict sequences of actions based on the selected subset of features.

During the machine learning process, the feature selector 260 provides the selected subset of features to the model trainer 265 as inputs to a machine learning algorithm to generate one or more training models. A wide variety of machine learning algorithms can be selected for use including algorithms such as support vector regression, ordinary least squares regression (OLSR), linear regression, logistic regression, stepwise regression, multivariate adaptive regression splines (MARS), locally estimated scatterplot smoothing (LOESS), ordinal regression, Poisson regression, fast forest quantile regression, Bayesian linear regression, neural network regression, decision forest regression, boosted decision tree regression, artificial neural networks (ANN), Bayesian statistics, case-based reasoning, Gaussian process regression, inductive logic programming, learning automata, learning vector quantization, informal fuzzy networks, conditional random fields, genetic algorithms (GA), Information Theory, support vector machine (SVM), Averaged One-Dependence Estimators (AODE), Group method of data handling (GMDH), instance-based learning, lazy learning, and Maximum Information Spanning Trees (MIST).

The model trainer 265 evaluates the machine learning algorithm's prediction performance based on patterns in the received subset of features processed as training inputs and generates one or more new training models 270. The generated training models, e.g., trained prediction models 270, are then capable of receiving user data including biometric information from outside of the machine learning process in which they were trained and generated to output predicted sequences of actions based on psychographic measurements associated with the biometric data.

As further shown in FIG. 2A, the trained prediction models 275 that were generated as a result of performing the machine learning process, can receive user data and process the user data to output predicted sequences of actions that are optimized based on determined psychographic measurements to the processor 220. For example, the trained prediction models 275, that were produced in the machine learning process, can be subsequently be included in an artificial intelligence system or an application configured to receive user data as prediction inputs and process the data to output predicted sequences of actions in regard to a specific objective and are optimized in regard to one or more psychographic characteristics. In some embodiments, the processor 245 can store the predicted sequences of actions that were output from the trained prediction model 275 in memory 250. In other embodiments, the outputted sequences of actions can be forwarded to communications module 240 for transmission to the client 105 via network 235. Once received by the client 105, the outputted sequences of actions can be transmitted to output device 210, such as a monitor, printer, portable hard drive or other storage device. In some embodiments, the output device 210 can include specialized virtual reality or augmented reality equipment that is configured to interface with client 105 and can display or otherwise provide the predicted sequences of actions to a user.

FIG. 2B illustrates an example block diagram of a system 200b using a machine learning process configured on a model training server 115A. The individual components and functionality of each component shown and described in relation to model training server 115A in FIG. 2B are identical to the components and respective functionality shown and described in relation to server 115 of FIG. 2A with the exception that the model training server 115A shown in FIG. 2B does not include one or more trained prediction models 275 as shown in FIG. 2A.

Instead, as shown in FIG. 2B, the system 200b includes a model training server 115A that is separate from a prediction server 115B. The prediction server 115B includes components and functionality similar to the server 115 shown in FIG. 2A with the exception that the prediction server 115B shown in FIG. 2B does not include a model training system, such as the model training system 255 shown in FIG. 2A. The prediction server 115B shown in FIG. 2B includes one or more trained prediction models 275.

The trained prediction models 275 configured on the prediction server 115B are models or algorithms that were generated from a machine learning process, such as training models 270 and have been trained in the machine learning process to output predicted sequences of actions based on determining psychographic measurements based on biometric data. For example, upon receiving user data from a client, for example client 105, the trained prediction models 275 can be employed to generate one or more sequences of actions that are optimized based on the received user data and/or the psychographic measurements determined based on the biometric data included in the received user data. In some embodiments, each of the trained prediction models 275 can generate a sequence of actions for a specific objective, correlation group, and/or psychometric characteristic. In some embodiments, each of the trained prediction models 275 can generate a sequence of actions based on a specific behavioral pattern present in the received user data.

As shown in FIG. 2B, system 200b also includes a model training server 115A. The model training server 115A includes a model training system 255 which implements a machine learning process and includes a feature selector 260, a model trainer 265, and one or more training models 270. In some embodiments, the training server 115A can be located in the same location as prediction server 115B. In other embodiments, the model training server 115A can be located in a remote location, for example in a second data center that is separately located from the data center or client location where the prediction server 115B is located. In some embodiments, the model training system 255, configured on the model training server 115A, can be utilized to evaluate different machine learning algorithms and generate one or more alternate training models 275. For example, based on using different subsets of features in the received user data as the training inputs to a different machine learning algorithm and process, the model training system 255 can train and output a different training model 275 than the trained prediction models 275 configured on prediction server 115B which can have been trained using a separate machine learning algorithm and process.

The model training system 255 can also be configured with a machine learning process to train and output one or more training models 275 that are capable of generating sequences of actions based on historical user data. In some embodiments, the model training system 255 can generate a model, such as trained prediction model 275 which can be capable of estimating a sequence of actions of a particular objective when one or more of the biometric parameters which are traditionally used to determine a particular sequence of actions for the particular objective are not available. For example, a sequence of actions can be optimized for a user's depressed psychographic state in regard to an objective of completing a credit card application via a sequence of fields in a web-form based on the user's rate of keystroke entry. If the client device is unable to output or measure the user's rate of keystroke, for example due to the user providing the field inputs as voice inputs to a form displayed on the user's mobile computing device via a microphone, a model can be generated to output a sequence of actions for completing the particular objective by a user determined to have a depressed psychographic state based on other available biometric parameters in the user data.

The model training system 255 can also be configured with a machine learning process to train and output multiple models, such as models 270 that have been trained in the machine learning process based on non-overlapping or partially overlapping sets of features. In some embodiments, the multiple models different sets of features can be implemented on the prediction server 115B to create a more robust system that includes an ensemble or collection of models. In such embodiments, the prediction server 115B can predict sequences of actions based on psychometric measurements for different users, objectives, correlation groups or biometric data attributes or other statistically correlated behavior patterns observed in the received user data more accurately in situations when certain biometric parameters used in a given model can be missing or incomplete.

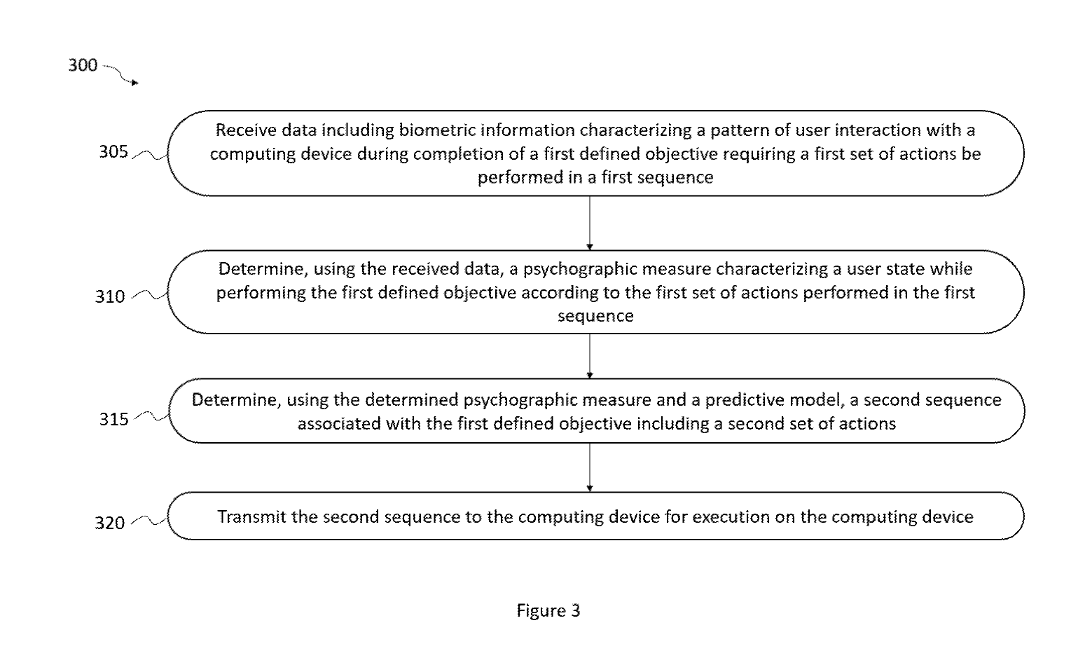

FIG. 3 is a flow diagram illustrating an exemplary embodiment of a process 300 for predicting sequences of actions based on psychographic measurements determined from biometric data using the client/server of the system 200a as shown and described in relation to FIG. 2A. In certain aspects, embodiments of the process 300 can include greater or fewer operations than illustrated in FIG. 3 and the operations can be performed in a different order than illustrated in FIG. 3.

In operation 305, the server 115 receives data generated from the client 105. The data can be collected using an object, such as a JavaScript object, which can be configured with listeners to collect event data related to the user's input and interaction with an application or interface on the client 105. The object can interface to an application programming interface (API) in order to provide the collected data to the server 115. A sample code snippet corresponding to an exemplary object configured to collect data from the client device 105 is shown below.

```
“_id”: {
“$oid”: “58efOeb3e4b0c2a7bfla7783”
“TOKEN”: “41934516-dbc6-35b5-de39-49e4955059aa-3179134203”,
“USERID”: “45070f6d-365c-4a2b-99dc-2f3987a295ab”,
“FORM1D”: “774a5373-3e58-4126-bc24-5d333e560313”,
“FORMNAME”:
“http://beta.formotiv.comidemositech_job_culture.html”,
“DEVICEID”: “3179134203”,
“STATUS”: “session_input”,
“ACTION”: “object_hover”,
“FIELDNAME”: “success_factor”,
“TIMESPENT”: 1116,
“TS”: {
    “$date”: “2017-04-13T05:37:55.8212”
    }
}
```

In the previous example related to the credit card application displayed as a web-form, the received data can include timing of actions in a sequence, typing speed, corrections, mouse activity and other metrics. The data includes biometric information relating to a user's physical interaction with a computing environment, application, or interface configured to receive user inputs in order to complete a specific objective based on performing a sequence of actions. The data and the included biometric information that is received by the server 115 can be received from a variety of sources by a server, which is configured with one or more trained prediction models that have been previously trained in a machine learning process to determine sequences of actions based on psychographic measurements determined from the biometric information. For example the data including the biometric information can be stored on one or more computing devices, such as the large-format computing device 105 and/or the small-format computing device 105 shown in FIG. 1. In addition, data including the biometric information can be stored in a network-accessible database, such as the database 110 as shown in FIG. 1. In some implementations, the database 110 can be on a client device, such as client device 105 shown in FIG. 2A.

The received data including the biometric information can include data that is associated with a particular user, group of users, computing environment, application, interface, objective, and/or method of data input. The received data can include data that is generated as a user completes actions to perform an objective, such providing form inputs (e.g., in for web-forms displayed in browser-based applications), reaching certain achievements and completing specific sequences of actions (e.g., in virtual reality or gaming applications), or any electronic input action that can be defined by success or failure outcomes, or by relative comparison to average behavior of a population (e.g., such as in voice applications, where a the speed of users speech can be compared to average or baseline metrics for a larger collection of users). The received data can also include biometric information such as typing speed, input device velocity and directional movement, time spent with visual goals or inputs in focus, keystroke versus backspace ratios, discrete changes/corrections to form inputs or repeated input goals, and similarly related activities that require manual bodily movement in order to register electronic input. The biometric information characterizes a pattern of user interaction with a computing device, such as client 105, during the completion of a defined objective which requires a set of actions to be performed in a particular sequence. The pattern of user interaction can be further influenced by a user's psychographic state and specifically a user's level of interest, opinion, and attitude. Analyzing biometric information across multiple subjects, for example in a test or training group, can yield more broad usability patterns and behavioral consistencies which can correlate to demographic groups of subjects. Evaluating received data associated with a particular context, such as partially completed web forms or fields in a credit card application, can be used to identify usability and behavioral patterns associated with positive and negative user engagement, which can lead to successful or failed performance of objectives.

In some embodiments, the data including biometric information can be received incrementally or on a predefined scheduled. In some embodiments, the data including biometric information can have been collected in the past and can be provided to the server 115 at a later date. In some embodiments, the data including biometric information can be received dynamically, in real-time or near real-time as the user provides user inputs and generates user data.

The received data including the biometric information can be processed by the server 115 to determine a behavioral normal input (BNI). The BNI can include a vector of biometric measurements that are associated with a specific action in a sequence of actions required to complete an objective. The BNI can be calculated within one standard deviation across the test group to which the biometric measurements are associated. A behavioral model can be created as a collection of BNIs for all actions within an objective and can used as a model of normal user behavior. The model can be trained by processing the data associated with a group of users.

In some embodiments, operation 305 can further include determining an environmental attribute that is associated with the received data. For example, an environmental attribute can include an identifier corresponding to a type of client 105, an initial use of a new device by a user, a new operating system on the client device 105, or a new geographic location in the example of navigation computing environments. Additionally, the operation 305, in some embodiments, can include determining a correlation group based on the received data. The correlation group can identify users for whom the received data includes statistical characteristics satisfying a similarity criteria that can be applied to two more users of a group of users. For example, a correlation group can be identified based on determining that three users performing the same sequence of actions have statistically similar keystroke speeds or statistically similar pace as they provide user inputs into a number of actions (or input fields) required for performing the sequence in order to complete the objective. The correlation group that is determined can be further used to determine the optimized sequence of actions that will be described later in relation to operation 315.

In operation 310, the server 115 determines a psychographic measure using the received data. The psychographic measure can include a characterization of a user's state while performing a defined objective according to a set of actions performed in a sequence. To determine the psychographic measure, the server 115 can evaluate the received data to determine significant correlation features using a machine learning process, such as a supervised regression learning process described earlier in relation to FIGS. 2A and 2B. The psychographic measures can be determined by evaluating changes or deviations in biometric information against standard deviations for a group of users. To do so, a behavioral psychographic deviation (BPD) is determined. A BPD can be defined as the Euclidean distance, computed using a k-nearest neighbor (KNN) algorithm, between a user's behavioral biometric measurements associated with one action or input and its corresponding BNI determined based on the behavioral model. In this formula, i represents each biometric measurement for the action, x(i) is the subject's measurement, and y(i) is the behavioral model's measurement. An abandonment threshold (AbT) can also be determined for the user input to an action. The AbT is the average BPD of an input, within one standard deviation, for the sample group of users that abandoned the objective on the same action requiring electronic input. A measure of psychographic load (PsL) can be determined as the average cumulative increase of abandonment threshold as the user proceeds to each successive electronic input required for a sequence of actions. The PsL can be used to determine a delta psychographic load (DPsL) by computing the rolling average increase in PsL as the user progresses through the set of actions in a sequence associated with a particular objective. A sample code snippet corresponding to an exemplary embodiment for calculating DsPL on the server 115 is shown below.

```
class PsychographicOptimize:
    def _init_(self):
        pass
    @staticmethod
    def calc_psl2(df):
        * PSL
        prev_index = None
        i = 0
        for index, row in df.iterrows( ):
            *print (index, row)
            if i == 0: * first row
                df.loc[index, ‘PsL’] = df[‘PsS’].mean( ) * mean
            else:
                df.loc[index, ‘PsL’] = int(row[‘PsS’] −
                df.loc[prev_index][‘PsS’])
            prev_index == index
            i += 1
        * Delta PSL
        i = 0
        for index, row in df.iterrows( ):
            if i = 0: * first row
                df.loc[index, ‘DeltaPsL’] = df[‘PsL’].mean( )
            else:
                df.loc[index, ‘DeltaPsL’] = int(row[‘PsL’] −
                df.loc[prev_index][‘PsL’])
            prev_index = index
            i += 1
        return df
    def sort_by_qv(df):
        df2 = df.sort_values(by=[‘QV’, ‘PsS’],
        ascending=[False, True])
        return PsychographicOptimize.calc_psl2(df2.reset_index( ))
    @staticmethod
    def getDPsLStats(df):
        max = df[‘DeltaPsL’].max( )
        min = df[‘DeltaPsL’].min( )
        gap = (df[‘DeltaPsL’].max( ) − df[‘DeltaPsL’].min( ))
        mean = df[‘DeltaPsL’].mean( )
        return (min, max, mean, gap)
```

In addition, a measure of psychographic sensitivity (PsS) can be further determined. PsS can be defined as one standard deviation of the normal model's calculation of the average range of the received biometric data for a single user input provided in response to an action. A qualification value (QV) can be determined as the percentage valuation (0-100%) for a specific user provided input that corresponds to the value of the input for the purposes of qualifying the user for the overall goal of the action being completed.

Combinations of sets of biometric data associated with successful and failed objectives can yield psychographic “signals,” which can be behavioral indicators for predicting classification. Upon analyzing failed transactions in addition to successful ones, the biometric data of individual users can then be compared to the behavior normal model using “proximity” scoring. The proximity scoring can be performed using a k-nearest neighbor algorithm or similar non-parametric method or algorithm used for classification. The proximity scoring correlates to users' psychographic reaction to a specific action and/or objective. The sum of the users' deviations from the normal model data (one standard deviation adjusted average) represents a user's behavioral deviation from the normal behavior. This behavioral deviation can include collection of the proximity scoring and can be used to predictively determine if a user is more likely to complete the objective successfully or if the user is more likely to abandon the objective. The predictive characteristics of the behavioral deviations can also be used to measure a user's psychographic reaction to providing input for a specific action, in the same way that the psychographic variables are used to determine the interest of a user in marketing materials. The behavioral indicators or signals can thus be used to predict a user's intention, motivation, and level of engagement toward a predefined objective. For example, the behavioral indicators can indicate is a user is highly engaged, driven to complete the objective, or if the user is casual, methodical, indecisive, not satisfied or convinced that completion of the objective, e.g., the submission of the credit card application is a necessary objective to pursue and accomplish.

In operation 315, the server 115 determines, using the determined psychographic measure and a predictive model, a second sequence associated with the first defined objective including a second set of actions. The second sequence can be generated as an optimized sequence using the DPsL so as to present the sequence of actions in an order that is more likely to achieve qualification or psychographic goals. Analysis of the psychographic “signals” yields a set of actions that most accurately correlate to the desired objective and can be labeled as “qualification values.” The Qualification values (QV) can then be used to change the sequence of actions for quick qualification. In addition, calculation of the DPsL results in a feature which can be used for supervised regression learning in a machine learning process, such that the DPsL can be minimized or maximized for a desired outcome. In this way, the sets of actions associated with a sequence to be performed in regard to a specific objective can include a list of actions that are ranked and are ordered based on a maximizing or minimizing the DPsL. For example, minimizing the DPsL optimization can reduce the highest and lowest PsL from the user experience by pairing or sequentially ordering actions in a successive manner that cancel positive and negative psychographic impact. Additionally, maximizing the DPsL optimization can pair or sequentially ordering actions in a successive manner that serves to maximize the psychographic effect to users for any user inputs and/or actions that are associated with an elevated or heightened emotional response. Maximizing the DPsL optimization can employ an alternate model to the k-nearest neighbor algorithm described as the k-furthest outlier (KFO) algorithm. The KFO algorithm can be used to measure Euclidian distance and return features that are furthest apart. In some embodiments, a correlation group can be determined based on the received data and can be used to determine the second sequence of actions.

Classification of user groups can use the psychographic measures along with known outcomes to build alternate models using known supervised regression models with alternate feature sets derived from the above data. The result becomes a smarter input for the predictive modeling system. A sample code snippet corresponding to an exemplary embodiment for optimizing the sequence of actions for DPsL using KNN and KFO on the server 115 is shown below.

```
def euclideanDistance(instance1, instance2, length, skip):
    distance = 0
    for x in range(skip, length):
        distance += pow((instance1[x] − instance2[x]), 2)
    return math.sqrt(distance)
def getNeighbors(trainingSet, testInstance, k):
    distances = [ ]
    length = len(testInstance)−1
    for x in range(len(trainingSet)):
        if trainingSet[x][0] != testInstance[0]:
              dist = euclideanDistance(testInstance, trainingSet[x],
              length, 1)
            distances.append((trainingSet[x], dist))
    distances.sort(key=operator.itemgetter(1))
    neighbors = [ ]
    for x in range(k):
        neighbors.append(distances[x][0])
    return neighbors
def getOutliars(trainingSet, testInstance, k):
    distances = [ ]
    length = len(testInstance)−1
    for x in range(len(trainingSet)):
        if trainingSet[x][0] != testInstance[0]:
              dist = euclideanDistance(testInstance, trainingSet[x],
              length, 1)
            distances.append((trainingSet[x], dist))
    distances.sort(key=operator.itemgetter(1), reverse=True)
    neighbors = [ ]
    for x in range(k):
        neighbors.append(distances[x][0])
    return neighbors
def run( ):
    df = pd.read_csv(“data/unoptimized.csv”, index_co1=“Fieldname”)
    df = psyop.calc_psl2(df)
    * optimize based on KNN:
    trainSet = [ ]
    for index, row in df[[‘BNI’, ‘PsS’, ‘PsL’, ‘DeltaPsL’]].iterrows( ):
        trainSet.append([str(index), row[‘BNI’],
                        row[‘PsS’], row[‘PsL’],
    row[‘DeltaPsL’]])
    sequence = [ ]
    for formfield in trainSet:
        if formfield[0] not in sequence:
            * already used this field
            sequence.append(formfield[0])
            * find n nearest neighbors
              knn3 = getNeighbors(trainSet, formfield, len(trainSet)−1)
              for neighbor in knn3:
                  if neighbor[0] in sequence:
                      pass
                  else:
                      sequence.append(neighbor[0])
                      print (“pair ” + formfield[0] +
                      “ with ” + str(neighbor[0]))
                      break
    print “Opt by Nearest Neighbor (KNN) sequence: ”
    print sequence
    * Now optimize by KFO
    trainSet = [ ]
    for index, row in df[[‘BNI’, ‘PsS’, ‘PsL’, ‘DeltaPsL’]].iterrows( ):
        trainSet.append([str(index),
                        row[‘BNI’],
                        row[‘PsS’],
                        row[‘PsL’],
                        row[‘DeltaPsL’]])
    sequence = [ ]
    for formfield in trainSet:
        if formfield[0] not in sequence:
            * already used this field
            sequence.append(formfield[0])
            * find n nearest neighbors
            knn3 = getOutliars(trainSet, formfield, len(trainSet)−1)
            for outliar in knn3:
                if outliar[0] in sequence:
                    pass
                else:
                    sequence.append(outliar[0])
                                print (“pair ” + formfield[0] +
                                “ with ” + str(outliar[0]))
                    break
    print “Opt by Furthest Outlier (KFO) sequence: ”
    print sequence
if _name_ == “_main_”:
    run( )
```

This process for optimization can be employed with any sequence of actions to be performed toward a defined objective in a computing system, application, or interface using any measurements of input. The included examples show the use case for web and mobile form input. Other domains, for example, the virtual and augmented reality or gaming industries, can employ this process so that actions can be used to measure the speed and movement of user input, time to complete goals, and pauses between discrete changes of input. Voice applications can measure tone, speed of speech and changes in volume to measure psychographic reaction to voice prompts for artificial intelligence applications. Internet of Things, drone navigation and autonomous driving technologies can likewise use sensor inputs and responses to optimize sequencing of directed and assigned actions toward defined objectives.

In operation 320, the server 115 transmits the second sequence to the computing device for execution. For example, based on determining the second or optimized sequence of actions that are associated with the first defined objective by the operations described above, the server 115 can transmit the second sequence to the computing device, e.g., client 105, for execution. Upon receiving the second sequence the client 105 can integrate the second sequence of actions into the computing environment, application or interface in which the first defined objective is being attempted or performed. The result of the integration is a modified sequence of actions that can be provided to a user to achieve, induce, affect or otherwise produce a particular psychographic characteristic. In some embodiments, the modified sequence of actions can include actions that require user input to cause execution of executable content that is configured on the client 105. For example, the modified sequence of actions can include actions which, upon user input, trigger or cause to execute a related action such as opening an attachment in an email, submitting a form, or receiving tokens in a gaming environment.

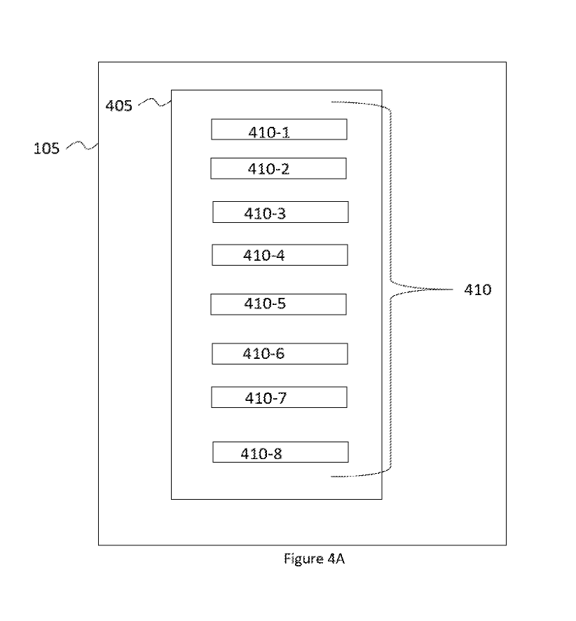

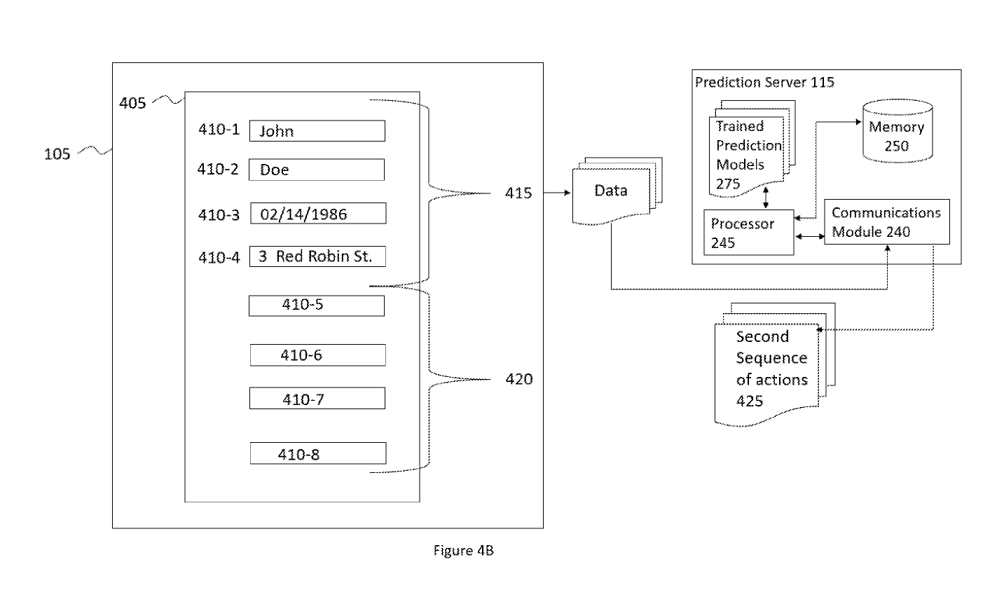

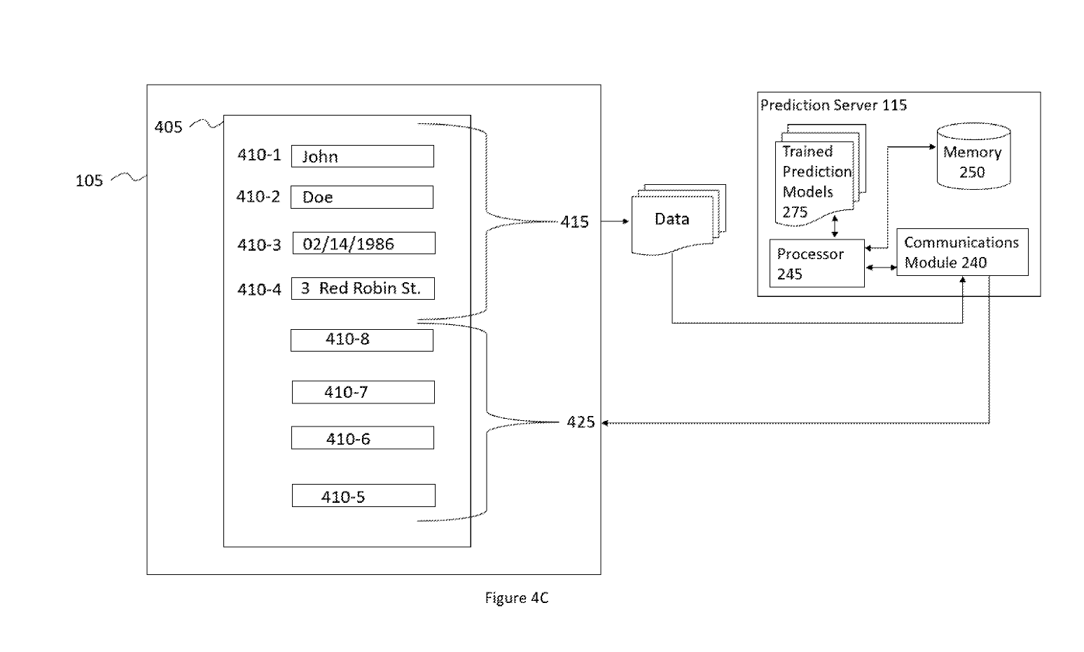

FIGS. 4A-4C illustrate exemplary embodiments of a prediction system operating to determine a sequence of actions based on psychographic measures determined from biometric information. FIGS. 4A-4C illustrate a prediction system, such as the prediction system 200 shown in FIG. 2, in operation to determine and provide a second sequence of actions based on psychographic measures determined from data, including biometric information, that is received in relation to a user's interaction with a first sequence of actions. The operation of the prediction system described in relation to FIGS. 4A-4C is discussed in the context of method 300 described in relation to FIG. 3 and the client 105 and server 115 described in relation to FIGS. 2A and 2B. The exemplary use case to be discussed in relation to FIGS. 4A-4C includes a web-form included in a credit card application that a user is interacting with on a client device 105.

As shown in FIG. 4A, the client 105 includes a web-form 405 that is provided for display in a web browser configured on the client 105. The web-form 405 includes a sequence of individual input fields 410, e.g., fields 410-1-410-8, that must receive inputs in order for the user to complete the objective of submitting the credit card application. The individual input fields 410-1-410-8 correspond to actions in a sequence. The user can interact with the web-form 405 using an input device such as a mouse, keyboard, or microphone that is interfaced with the client 105. An object or other listening functionality, described in relation to FIG. 3A above has been configured on the client 105 to collect data including biometric data corresponding to the users entry of inputs into the actions 410 and provide the data including the biometric information to the prediction server 115 for prediction of a sequence of actions based on psychographic measures determined from the entry of data into the actions or fields 410.

As shown in FIG. 4B, the user has provided input into a first set 415 of actions 410 (or input fields 410-1-410-4), thereby completing the first half of the credit card application. Data has yet to be provided in the second half of the credit card application as shown by the empty input fields corresponding to actions 420. For example, the user has entered his first name (“John”), his last name (“Doe”), his date of birth (“Feb. 14, 1986”), and his street address (“3 Red Robin St.”). Data associated with the inputs provided by the user in the first set 415 of actions 410 is received by the prediction server 115. The received data includes biometric information associated with the speed of the keystrokes performed by the user to provide user input corresponding to the user's first name in action 410-1, last name in action 410-2, date of birth in action 410-3, and street address in action 410-4. Based on completing the first set of actions 415, the data is collected and provided to the prediction server 115 where it is processed to determine a psychographic measure characterizing the user's state while completing the actions 415 in the illustrated sequence as described in relation to operation 310 of method 300 of FIG. 3. For example, assume that the data including biometric information indicates that the user has entered his data into each of the inputs or actions of the first sequence, e.g., actions 410-1-410-4, at a very slow keystroke speed with long delays between data entry into successive actions 410. The data received by the prediction server 115, and specifically the trained prediction model 275, would cause the trained prediction model 275 to determine that the user's psychographic state includes characteristics of sadness, disinterest, skepticism, and pessimism. The trained prediction model 275 has been trained to determine these psychographic characteristics based on the speed of the keystrokes entered in association with the user's inputs to actions 410-1-410-4.

Based on determining the psychographic measures associated with entry of the first set of actions 415, the server 115 can proceed to generate a second sequence of actions 425 that are optimized based on the psychographic measures determined from the biometric information included in the received data. The optimized sequence of actions 425 are determined using the psychographic measures and a predictive model trained in a machine learning process to output a sequence of actions that has been ordered so as to achieve a desired psychographic response or state in the user according to operation 315 of method 300 of FIG. 3. The prediction server 115 can then transmit the second sequence of actions 425 to the client 105 for integration into the web-form 405 according to operation 320 of method 300 described in relation to FIG. 3.

As shown in FIG. 4C, the second sequence of actions 425, which have been optimized for the psychographic characteristics determined for the user in response to input to the first sequence of actions 415 are different than the previous sequence of remaining actions associated with the second half 420 of the web-form 405. The prediction server 115, has determined the user is in a negative psychographic state and likely experiencing sadness, disinterest, skepticism, and pessimism in response to objective of submitting the credit card application and first sequence of actions 415. As a result the prediction server 115 has generated an optimized sequence of actions 425 which include a different order of actions 410-5-410-8 as compared to the previous order of actions 420 shown in FIG. 4B. For example, based on determining the user's negative psychographic state based on input of the first sequence 415 of actions, the prediction server 115, can generate the second sequence 425 of action such that the order of the actions in the sequence 425 can be determined as least likely to cause further negative psychographic characteristics. In other embodiments, the order of the actions in the second sequence 425 can be determined such that the order is optimized to minimize an increase in the psychographic load (PsL) or to decrease the delta psychographic load (DPsL) associated with the rolling average increase in PsL as the user progresses through the second set 425 of actions.

As further shown in FIG. 4C, the second sequence 425 of actions has been integrated into the web-form 405 of client 105 and has been executed to dynamically update the second half of the application to require the user to provide inputs to the psychographically optimized second sequence 425 of actions. In this way, the prediction server 115 has improved the functionality of the client 105 by providing an optimized interface including the second sequence 425 of actions which have been determined with respect to the user's psychographic state.

Exemplary technical effects of the methods, systems, and computer-readable medium described herein include, by way of non-limiting example, determining and generating a sequence of actions that can be integrated into a client device 105 to provide an improved interface to a user performing a sequence of actions in regard to a defined objective. The improved interface can further improve the rate of objective completion on the client device 105, thereby generating a greater quantity of user inputs. Additionally, the improved interface provides more efficient execution of individual actions by providing the actions in an ordered sequence that is customized for the psychographic state of the user. In this way, the client device 105 can be improved to execute functionality that is associated with the actions more reliably and thereby improve the functionality of the computer with respect to the objective the client device 105 is configured to perform.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment can be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, can be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language can correspond to the precision of an instrument for measuring the value. Here and throughout the specification and claims, range limitations can be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
receiving data including biometric information characterizing a pattern of user interaction with a computing device during completion of a first defined objective requiring a first set of actions be performed in a first sequence, the computing device including at least one data processor and configured to provide the first defined objective for user input;
determining, using the received data, a psychographic measure characterizing a user state while performing the first defined objective according to the first set of actions performed in the first sequence;
determining, using the determined psychographic measure and a predictive model, a second sequence associated with the first defined objective including a second set of actions, the predictive model trained to output the second sequence to affect the psychographic measure of the user completing the first defined objective according to the second set of actions to be provided in the second sequence, the second set of actions different than the first set of actions; and
transmitting the second sequence to the computing device for execution on the computing device.

2. The method of claim 1, further comprising a second predictive model, the second predictive model trained to output a third sequence to affect the psychographic measure of the user completing a second defined objective according to a third set of actions to be provided in the third sequence, the third set of actions different than the first and second set of actions.

3. The method of claim 2, wherein the first, second, and third sets of actions include a list of actions, the actions included in the list of actions being ranked based on a magnitude of the one or more determined psychographic measurements.

4. The method of claim 1, further comprising:
determining an environmental attribute associated with the received data, the environmental attribute characterizing an attribute of the computing device configured to provide the first defined objective for user input;
determining a correlation group based on the received data, the correlation group identifying a group of users for whom the received data includes statistical characteristics satisfying a similarity criteria applied to two or more users of the group of users; and
determining the second sequence based on the determined correlation group.

5. The method of claim 1, wherein the computing device is configured to receive user input in a browser-based web form, in a virtual reality environment, in a gaming environment, in a voice-based interaction system, in a text-based interaction system, or in a navigation environment.

6. The method of claim 1, wherein the user state is associated with an attitude, an interest, an opinion, a value, or a belief of a user performing the first defined objective in the first sequence.

7. The method of claim 1, wherein the first set of actions and the second set of actions includes one or more actions requiring user input to cause execution of executable content configured on the computing device.

8. The method of claim 1, wherein transmitting the second sequence further comprises:
transmitting the second sequence to a computing environment including at least one data processor, the computing environment configured with the computing device and executing an application requiring user input to perform the first defined objective.

9. The method of claim 8, further comprising:
integrating the second sequence including the second set of actions into the computing environment; and
executing the application to cause the second set of actions to be provided for user input in the application.

10. The method of claim 1, further comprising determining the psychographic measure as an average cumulative increase of an abandonment threshold determined based on successive completion of two or more actions in the first set of actions to be performed in the first sequence.

11. The method of claim 10, wherein the abandonment threshold is an average of a deviation of the psychographic measure associated with an action in the first set of actions, within one standard deviation, the abandonment threshold determined with respect to a sample user group abandoning the first defined objective at the same action in the first set of actions.

12. The method of claim 11, wherein the psychographic deviation is determined as a Euclidean distance between the received data associated with a user's performance of one action in the first set of actions and a vector of behavior normal data associated with a user's performance of the same one action in the first set of actions, the behavior normal data included in a training model used in a machine learning process to train the predictive model.

13. The method of claim 1, wherein the received data is generated by an object configured on the computing device and including one or more functions to collect and transmit the received data, via one or more application programming interfaces, to a server including at least one processor.

14. The method of claim 1, wherein the psychographic measure and the second sequence are determined by a server communicatively coupled to the computing device, the server including at least one data processor.

15. A system comprising:
a memory storing computer-readable instructions and a plurality of prediction models; and
a processor, the processor configured to execute the computer-readable instructions, which when executed, cause the processor to perform operations comprising:
receiving data including biometric information characterizing a pattern of user interaction with a computing device during completion of a first defined objective requiring a first set of actions be performed in a first sequence, the computing device including at least one data processor and configured to provide the first defined objective for user input;
determining, using the received data, a psychographic measure characterizing a user state while performing the first defined objective according to the first set of actions performed in the first sequence;
determining, using the determined psychographic measure and a predictive model, a second sequence associated with the first defined objective including a second set of actions, the predictive model trained to output the second sequence to affect the psychographic measure of the user completing the first defined objective according to the second set of actions to be provided in the second sequence, the second set of actions different than the first set of actions; and
transmitting the second sequence to the computing device for execution on the computing device.

16. The system of claim 15, further comprising a second predictive model, the second predictive model trained to output a third sequence to affect the psychographic measure of the user completing a second defined objective according to a third set of actions to be provided in the third sequence, the third set of actions different than the first and second set of actions.

17. The system of claim 16, wherein the first, second, and third sets of actions include a list of actions, the actions included in the list of actions being ranked based on a magnitude of the one or more determined psychographic measurements.

18. The system of claim 1, wherein the computer-readable instructions, which when executed, cause the processor to perform operations further comprising:
determining an environmental attribute associated with the received data, the environmental attribute characterizing an attribute of the computing device configured to provide the first defined objective for user input;
determining a correlation group based on the received data, the correlation group identifying a group of users for whom the received data includes statistical characteristics satisfying a similarity criteria applied to two or more users of the group of users; and
determining the second sequence based on the determined correlation group.

19. The system of claim 15, wherein the computing device is configured to receive user input in a browser-based web form, in a virtual reality environment, in a gaming environment, in a voice-based interaction system, in a text-based interaction system, or in a navigation environment.

20. The system of claim 15, wherein the user state is associated with an attitude, an interest, an opinion, a value, or a belief of a user performing the first defined objective in the first sequence.

21. The system of claim 15, wherein the first set of actions and the second set of actions includes one or more actions requiring user input to cause execution of executable content configured on the computing device.

22. The system of claim 15, wherein the computer-readable instructions, which when executed, cause the processor to perform the operation for transmitting the second sequence further comprising:
transmitting the second sequence to a computing environment including at least one data processor, the computing environment configured with the computing device and executing an application requiring user input to perform the first defined objective.

23. The system of claim 22, wherein the computer-readable instructions, which when executed, cause the processor to perform the operation for transmitting the second sequence further comprising:
integrating the second sequence including the second set of actions into the computing environment; and
executing the application to cause the second set of actions to be provided for user input in the application.

24. The system of claim 15, wherein the computer-readable instructions, which when executed, cause the processor to perform the operation for determining the psychographic measure as an average cumulative increase of an abandonment threshold determined based on successive completion of two or more actions in the first set of actions to be performed in the first sequence.

25. The system of claim 24, wherein the abandonment threshold is an average of a deviation of the psychographic measure associated with an action in the first set of actions, within one standard deviation, the abandonment threshold determined with respect to a sample user group abandoning the first defined objective at the same action in the first set of actions.

26. The system of claim 25, wherein the psychographic deviation is determined as a Euclidean distance between the received data associated with a user's performance of one action in the first set of actions and a vector of behavior normal data associated with a user's performance of the same one action in the first set of actions, the behavior normal data included in a training model used in a machine learning process to train the predictive model.

27. The system of claim 15, wherein the received data is generated by an object configured on the computing device and including one or more functions to collect and transmit the received data, via one or more application programming interfaces, to a server including at least one processor.

28. The system of claim 15, wherein the psychographic measure and the second sequence are determined by a server communicatively coupled to the computing device, the server including at least one data processor.

29. A non-transitory computer readable storage medium containing program instructions, which when executed by at least one data processor causes the at least one data processor to perform operations comprising:
receive data including biometric information characterizing a pattern of user interaction with a computing device during completion of a first defined objective requiring a first set of actions be performed in a first sequence, the computing device including at least one data processor and configured to provide the first defined objective for user input;
determine, using the received data, a psychographic measure characterizing a user state while performing the first defined objective according to the first set of actions performed in the first sequence;
determine, using the determined psychographic measure and a predictive model, a second sequence associated with the first defined objective including a second set of actions, the predictive model trained to output the second sequence to affect the psychographic measure of the user completing the first defined objective according to the second set of actions to be provided in the second sequence, the second set of actions different than the first set of actions; and
transmit the second sequence to the computing device for execution on the computing device.
